(19) United States
(12) Patent Application Publication
(10) Pub. No.: US 2024/0265287 A1
(43) Pub. Date: Aug. 8, 2024

(54) Integrated Photonic-Based Programmable High-Dimensional Quantum Computation Chip Structure

(71) Applicant: National Innovation Institute of Defense Technology, Academy of Military Sciences PLA China, Beijing (CN)

(72) Inventors: Xiaogang QIANG, Beijing (CN); Chao WANG, Beijing (CN)

(21) Appl. No.: 18/289,747

(22) PCT Filed: Sep. 27, 2022
(86) PCT No.: PCT/CN2022/121834

§ 371 Date: Nov. 6, 2023

(30) Foreign Application Priority Data
Sep. 28, 2021 (CN) 202111143350.X

(51) Int. Cl. G06N 10/40; H04B 10/70

(52) U.S. Cl. CPC G06N 10/40; H04B 10/70

(57) ABSTRACT

Provided is an integrated photonic-based programmable high-dimensional quantum computation chip. In order to realize programmable high-dimensional quantum computation, different linear combinations are performed on unitary transformation by regulating a multi-photon path entangled state originating from an entangled multi-photon source and optical unitary transformation realized by a universal linear optical network. So the chip involves: a configurable entangled multi-photon source, including a linear coefficient configuration network, N entangled multi-photon sources and a wavelength division multiplexer, and configured to generate multiple photons, configure coherent pump light of the N entangled multi-photon sources, and further to obtain linear term coefficients and respectively output multiple photons according to wavelengths; an initial state preparation linear optical network, configured to prepare a quantum initial state for the photons outputted by the configurable entangled multi-photon source; a unitary operator configuration linear optical network, configured to achieve optical unitary transformation and perform beam combination which means a linear combination of unitary transformations; and a projective measurements linear optical network, configured to perform projective measurements on a quantum state after beam combination.

### CROSS-REFERENCE TO RELATED APPLICATION

The present disclosure is based upon and claims priority to Chinese Patent Application No. CN202111143350.X filed on Sep. 28, 2021 and entitled “Integrated Photonic-Based Programmable High-Dimensional Quantum Computation Chip Structure”, the disclosure of which is hereby incorporated by reference in its entirety.

### TECHNICAL FIELD

The present disclosure relates to the technical field of quantum computation, and in particular, to an integrated photonic-based programmable high-dimensional quantum computation chip.

### BACKGROUND

Quantum computation is a new computation mode that follows the laws of quantum mechanics by regulating quantum information units, that is, qubits, to perform computation. Quantum computation uses the superposition, interference and entanglement properties of quantum for computation, and has natural parallelism and large information storage capacity, such that quantum computation has a huge potential that is unmatched by classical computation, and has a huge application potential in many fields such as large number prime factorization, database search, and chemical molecular simulation.

A linear optical system is one of the main physical pathways for realizing quantum computation. The main advantages of the linear optical system include the following: photons have a long coherence time and are not susceptible to decoherence due to external environmental interference; the photons are easy to achieve high-precision control; and the photons have multiple degrees of freedom, and may be used for encoding high-dimensional quantum.

Many quantum computation applications have been implemented by performing experiments in the linear optical systems, most of which are discrete element optical systems. When implementing programmable quantum computation, discrete optical elements need to be modulated, and these experiments are mostly difficult and have high requirements on experimental technologies. In addition, a free space linear optical system needs a large number of discrete optical elements, so the entire system is huge in volume, and each discrete element is susceptible to external ambient factors such as temperatures and vibration, such that the stability and extendibility of the system are limited.

An integrated photonic quantum chip is to integrate discrete linear optical elements, in a thin film form, onto a single semiconductor integrated chip by using integrated photonic technology. Compared with the discrete element optical system, the volume is significantly decreased, and the entire system has better stability and better extendibility because of high integration. The integrated photonic quantum chip can implement miniaturization and integration of the discrete element optical systems on a huge optical platform, such that the integrated photonic quantum chip is considered as a most effective way to realize large-scale photonic quantum computation systems.

Currently, most of linear photonic quantum systems use a spontaneous parametric down-conversion or four-wave mixing effect to probabilistically generate a pair of photons, such that deterministic single photon sources may be realized theoretically. However, there are still quite a number of technical problems to overcome, so photon resources are relatively expensive. In another aspect, a single photon has various degrees of freedom, and performing high-dimensional encoding and control on the single photon can significantly reduce the demands of photon resources during photonic quantum computation. According to the preparation and control properties of photon high-dimensional quantum states, and in combination with the advantages of integrated photonic quantum chip technology, new approaches can break a new path for improving the computation capability of a linear photonic quantum computation system.

### SUMMARY

Embodiments of the present disclosure provide an integrated photonic-based programmable high-dimensional quantum computation chip. Through the on-chip implementation of the preparation, control and projective measurement of a high-dimensional quantum state, a universal high-dimensional quantum computation chip that enables programmable control of high-dimensional quantum state input, high-dimensional quantum gate operation, and high-dimensional quantum state projective measurement is realized.

The embodiments of the present disclosure provide an integrated photonic-based programmable high-dimensional quantum computation chip, which includes: a linear coefficient configuration network, N entangled multi-photon sources and a wavelength division multiplexer, configured to generate multiple photons, the number of entangled photons generated by each entangled multi-photon source being recorded as P, respectively output the photons with different wavelengths by means of the wavelength division multiplexer, and configure, according to an output path, pump light entering an interference configuration network by adjusting a first phase shifter and a second phase shifter in the linear coefficient configuration network, so as to obtain a group of linear configuration coefficients, which are recorded as α₁, α₂, . . . , and α_{N}; an initial state preparation linear optical network O, connected to the configurable entangled multi-photon source, formed into corresponding O₁, O₂ . . . O_{P} according to the wavelengths of the photons outputted by the wavelength division multiplexer, and configured to prepare an initial state for the photons outputted by the configurable entangled multi-photon source; a unitary operator configuration linear optical network U, correspondingly connected to the initial state preparation linear optical network O, so as to form corresponding U₁⁽ⁱ⁾, U₂⁽ⁱ⁾ . . . U_{P}⁽ⁱ⁾ (i=1, 2, . . . N), and configured to perform unitary transformation, and achieve a linear combination of unitary operators after beam combination is performed, so as to obtain a final quantum state result: (Σᵢ₌₁^{N}αᵢU₁⁽ⁱ⁾⊗U₂⁽ⁱ⁾⊗ . . . U_{P}⁽ⁱ⁾)O₁⊗O₂⊗ . . . O_{P}|0 [symbol] ; and a projective measurement linear optical network T, correspondingly connected to the unitary operator configuration linear optical network U, so as to form corresponding T₁, T₂ . . . T_{P}, and configured to perform projective measurement on a quantum state after beam combination.

According to the integrated photonic-based programmable high-dimensional quantum computation chip provided in the embodiments of the present disclosure, the initial state preparation linear optical network, the unitary operator configuration linear optical network, and the projective measurement linear optical network all belong to universal linear optical networks.

According to the integrated photonic-based programmable high-dimensional quantum computation chip provided in the embodiments of the present disclosure, the configurable entangled multi-photon source, the initial state preparation linear optical network, the unitary operator configuration linear optical network, and the projective measurement linear optical network all achieve path encoding utilizing the first phase shifter and the second phase shifter.

According to the integrated photonic-based programmable high-dimensional quantum computation chip provided in the embodiments of the present disclosure, the linear coefficient configuration network includes a log₂ N level Mach-Zehnder interferometer, which is arranged in the form of a binary tree, that is, each output port of the previous level Mach-Zehnder interferometer is connected to an input port of the next level Mach-Zehnder interferometer, and a 2^{┌log}^{₂} ^{N┐}th output port of the last level Mach-Zehnder interferometer is connected to one-second phase shifter and one entangled multi-photon source; the Mach-Zehnder interferometer includes one first phase shifter and two multimode interferometers connected to the first phase shifter.

In the embodiments of the present disclosure, the integrated photonic-based programmable high-dimensional quantum computation chip may be implemented in the form of quantum computation of (Σᵢ₌₁^{N}αᵢU₁⁽ⁱ⁾⊗U₂⁽ⁱ⁾⊗ . . . U_{P}⁽ⁱ⁾)O₁⊗O₂⊗ . . . O_{P}|0 [symbol] , where U_target=Σᵢ₌₁^{N}αᵢU₁⁽ⁱ⁾⊗U₂⁽ⁱ⁾⊗ . . . U_{P}⁽ⁱ⁾ is a quantum operation to be implemented, and represents a linear combination of a plurality of linear optical unitary transformations U; αᵢ is a linear term coefficient; and a computation initial state is O₁⊗O₂⊗ . . . O_{P}|0 [symbol] , which is in a multi-photon high-dimensional quantum state.

According to the integrated photonic-based programmable high-dimensional quantum computation chip structure provided in the embodiments of the present disclosure, the configurable entangled multi-photon source generates the photons with P wavelengths; and the photons of the P wavelengths are respectively correspondingly routed to P groups of initial state preparation linear optical networks, where P is a natural number, and P≥2.

According to the integrated photonic-based programmable high-dimensional quantum computation chip structure provided in the embodiments of the present disclosure, the initial state preparation linear optical network may include a multi-level chain structure.

According to the integrated photonic-based programmable high-dimensional quantum computation chip structure provided in the embodiments of the present disclosure, the unitary operator configuration linear optical network may be a triangularly distributed optical network structure.

According to the integrated photonic-based programmable high-dimensional quantum computation chip structure provided in the embodiments of the present disclosure, the projective measurement linear optical network may include an inverted tree structure.

According to the integrated photonic-based programmable high-dimensional quantum computation chip structure provided in the embodiments of the present disclosure, the first phase shifter and the second phase shifter adjust each path of light through external classical control signals, so as to achieve path encoding.

According to the integrated photonic-based programmable high-dimensional quantum computation chip structure provided in the embodiments of the present disclosure, there are N initial state preparation linear optical networks in each of the P groups of initial state preparation linear optical networks; correspondingly, the unitary operator configuration linear optical networks are divided into P groups, and each group has N unitary operator configuration linear optical networks; and each group of unitary operator configuration linear optical networks is correspondingly connected to one group of initial state preparation linear optical networks and one projective measurement linear optical network.

According to the integrated photonic-based programmable high-dimensional quantum computation chip structure provided in the embodiments of the present disclosure, by generating the plurality of photons, encoding the path of the entangled multi-photon source, and performing, by means of a universal linear optical network, initial state preparation, unitary transformation, linear combination, beam combination and projective measurement on the photons respectively routed according to the wavelengths, the generation, control and measurement of quantum information carriers are realized on a single integrated photonic chip, so as to make it possible to realize an integrated, miniaturized, extensible, and programmable quantum computation apparatus.

According to the integrated photonic-based programmable high-dimensional quantum computation chip structure provided in the embodiments of the present disclosure, the integration of photonic chips for quantum computation is realized. Compared with a discrete element optical system, the volume is significantly decreased, and the entire system has better stability and better extendibility because of high integration. Scaling the integrated photonic-based programmable high-dimensional quantum computation chip technology can support extensible implementation based on a linear combination scheme of unitary operators, so as to construct a fully programmable high-dimensional qubits computing chip, thereby achieving photon-based multi-qubits quantum information processing.

In the embodiments of the present disclosure, high-dimensional qubits computation is realized through the linear combination of unitary operator based on path encoding; and through regulating the multi-photon path entangled state prepared by the configurable entangled multi-photon source and optical unitary transformation realized by the unitary operator configuration linear optical network, high-dimensional quantum computation is realized in combination with on-chip high-dimensional multi-photon path entanglement and by means of path encoding-based linear combination.

### BRIEF DESCRIPTION OF THE DRAWINGS

In order to illustrate the technical solutions in the present disclosure or technical solutions in the prior art more clearly, the drawings used in the technical description of the embodiments will be briefly described below. The drawings in the following descriptions are some embodiments of the present disclosure. Other drawings can be obtained from those skilled in the art according to these drawings without any creative work.

FIG. 1 is a schematic structural diagram of an integrated photonic-based programmable high-dimensional quantum computation chip according to an embodiment of the present disclosure.

FIG. 2 is a schematic structural diagram of an integrated photonic-based programmable high-dimensional quantum computation chip according to an embodiment of the present disclosure.

FIG. 3 is a schematic flowchart of a quantum computation process in an integrated photonic-based programmable high-dimensional quantum computation chip according to an embodiment of the present disclosure.

FIG. 4 is a schematic diagram of an optical network structure for initial state preparation according to an embodiment of the present disclosure.

FIG. 5 is a schematic diagram of a triangularly-distributed optical network structure according to an embodiment of the present disclosure.

FIG. 6 is a schematic diagram of an optical network structure for photon beam combination according to an embodiment of the present disclosure.

FIG. 7 is a schematic diagram of an optical network structure for projective measurement according to an embodiment of the present disclosure.

FIG. 8 is a schematic structural diagram of an integrated photonic chip using a two-photon entangled state to realize four-dimensional qubit computation according to an embodiment of the present disclosure.

### DETAILED DESCRIPTION OF THE EMBODIMENTS

In order to make the objectives, technical solutions, and advantages of the present disclosure clearer, the technical solutions of the present disclosure will be clearly and completely described below concerning the specific embodiments and corresponding drawings of the present disclosure. The described embodiments are only part of the embodiments of the present disclosure, not all the embodiments. Based on the embodiments in the present disclosure, all other embodiments obtained by those of ordinary skill in the art without creative work shall fall within the protection scope of the present disclosure.

The technical solutions provided in each embodiment of the present disclosure are described in detail below with reference to the drawings.

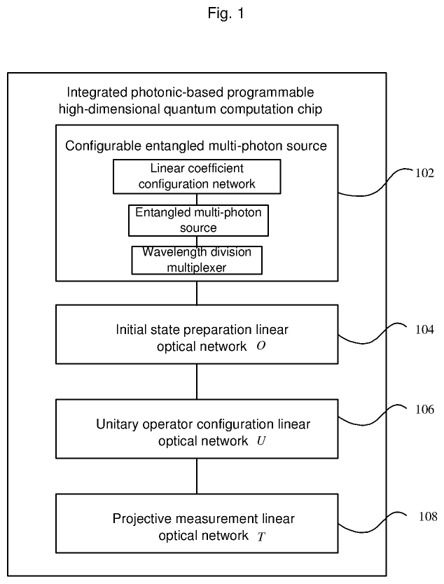

As shown in FIG. 1, an embodiment of the present disclosure provides an integrated photonic-based programmable high-dimensional quantum computation chip, which includes a configurable entangled multi-photon source, an initial state preparation linear optical network, a unitary operator configuration linear optical network, and a projective measurement linear optical network. The configurable entangled multi-photon source 102 includes a linear coefficient configuration network, N entangled multi-photon sources and a wavelength division multiplexer, and is configured to: generate multiple photons, the number of entangled photons generated by each entangled multi-photon source being recorded as P, respectively output the photons with different wavelengths by means of the wavelength division multiplexer, and configure, according to an output path, pump light entering an interference configuration network by adjusting a first phase shifter and a second phase shifter in the linear coefficient configuration network, so as to obtain a group of linear configuration coefficients, which are recorded as α₁, α₂, . . . , and α_{N}.

The initial state preparation linear optical network 104 is connected to the configurable entangled multi-photon source, formed into corresponding O₁, O₂ . . . O_{P} According to the Wavelengths of the photons outputted by the wavelength division multiplexer, and configured to prepare an initial state for the photons outputted by the configurable entangled multi-photon source.

The unitary operator configuration linear optical network 106 is correspondingly connected to the initial state preparation linear optical network O, so as to form corresponding U₁⁽ⁱ⁾, U₂⁽ⁱ⁾ . . . U_{P}⁽ⁱ⁾ (i=1, 2, . . . N) and configured to perform the unitary transformation, and achieve a linear combination of unitary operators after beam combination is performed, so as to obtain a final quantum state result: Σᵢ₌₁^{N}αᵢU₁⁽ⁱ⁾⊗U₂⁽ⁱ⁾⊗ . . . U_{P}⁽ⁱ⁾)O₁⊗O₂⊗ . . . O_{P}|0 [symbol] .

Specifically, the linear combination refers to a linear combination of unitary transformations realized by different optical networks.

The projective measurement linear optical network 108 is correspondingly connected to the unitary operator configuration linear optical network U, so as to form corresponding T₁, T₂ . . . T_{P}, and configured to perform projective measurement on a quantum state after beam combination.

Specifically, projective measurement is to perform spectral decomposition on a Hermitian operator representing an observable measurement on a system state space into a plurality of measurement operators. The measurement operator is a projection of the Hermitian operator facing toward an eigensubspace generated by a corresponding eigenvalue.

In the embodiments of the present disclosure, linear term coefficients of an entangled multi-photon source path may be configured by encoding a configurable entangled multi-photon source module, and an initial state and unitary operators of the linear combination may be configured through the initial state preparation linear optical network and the unitary operator configuration linear optical network, such that organic integration and combination use of the multi-photon source that may prepare the multi-photon path entangled state and the universal linear optical network that may realize unitary transformation are realized. The integrated photonic-based programmable high-dimensional quantum computation chip provided in the embodiments of the present disclosure has programmable and scalable features. By regulating the multi-photon path entangled state prepared by the entangled multi-photon source and optical unitary transformation realized by the universal linear optical network, the integrated photonic-based programmable high-dimensional quantum computation chip can prepare a multi-photon high-dimensional entangled quantum state, so as to realize programmable high-dimensional qubits computation.

An integrated photonic-based quantum chip technology has now achieved greater development. The technology uses a semiconductor micro/nano processing technology to integrate a discrete optical element onto a single chip. Compared to discrete optical elements, it has advantages such as small size, high stability, and strong extendibility, the technology is an effective approach for realizing a large-scale photonic quantum computation system.

The field of integrated photonic quantum chips has been developing rapidly in recent years; and important components required to realize integrated photonic quantum computation have been experimentally verified, including on-chip single photon sources and entangled photon sources, on-chip high-precision quantum state manipulation, and on-chip linear optical networks. On the basis of these basic units or modules, by designing a photonic chip structure, quantum information carriers-photons can be generated, controlled and measured on the single chip, so as to make it possible to realize an integrated, miniaturized, extensible, and programmable quantum computation apparatus.

Scaling the integrated photonic quantum chip technology can support extensible implementation based on a linear combination scheme of unitary operators, so as to construct a fully programmable high-dimensional qubits computing chip, thereby achieving photon-based multi-qubits quantum information processing. In addition, the manufacturing process of the programmable high-dimensional quantum computation chip based on integrated photonic such as a silicon-based optical waveguide may be compatible with that of a Complementary Metal Oxide Semiconductor (CMOS). The integrated photonic-based programmable high-dimensional quantum computation chip in the embodiments of the present disclosure can be further fused with a traditional CMOS computation chip, so as to design a photonic quantum information processing chip for realizing optoelectronic fusion and hybrid architecture in the future.

In the embodiments of the present disclosure, the integrated photonic-based programmable high-dimensional quantum computation chip may further be provided with an integrated photonic source, which is configured to generate the photons and output the photons to the linear coefficient configuration network. The integrated photonic-based programmable high-dimensional quantum computation chip may further be integrated with a single photon detector, which is configured to detect the photons outputted by the linear optical network. The single photon detector may be an avalanche photodiode or a superconduction nanowire detector.

The initial state preparation linear optical network, the unitary operator configuration linear optical network, and the projective measurement linear optical network all belong to universal linear optical networks.

The configurable entangled multi-photon source, the initial state preparation linear optical network, the unitary operator configuration linear optical network, and the projective measurement linear optical network all achieve path encoding by means of the first phase shifter and the second phase shifter.

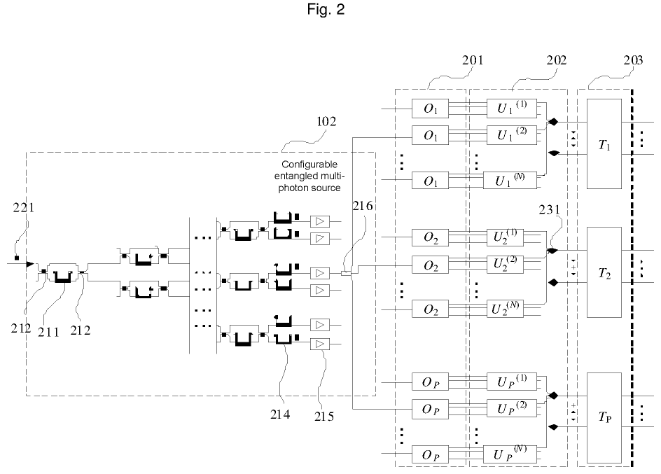

As shown in FIG. 2, a Mach-Zehnder interferometer includes a first phase shifter 211 and two multimode interferometers 212 connected to the first phase shifter 211. As shown in FIG. 2, the phase shifter 211 is a first phase shifter, and the phase shifter 214 is a second phase shifter.

As shown in FIG. 2, the first-level Mach-Zehnder interferometer of the log₂ N-level Mach-Zehnder interferometer receives an input light beam 221 outside the configurable entangled multi-photon source 102. The log₂ N-level Mach-Zehnder interferometer forms N paths of light according to the input light beam 221, and outputs the N paths of light to the N entangled multi-photon sources 215. Herein, each entangled multi-photon source is connected to one second phase shifter 214. All phase shifters of a configurable entangled photon source module are configured to adjust each path of light outputted by the linear coefficient configuration network, so as to configure linear term coefficients. Specifically, the first phase shifter and the second phase shifter adjust each path of light by means of external classical control signals, so as to obtain the linear term coefficients. As shown in FIG. 2, the configurable entangled multi-photon source 102 further includes the wavelength division multiplexer 216.

As shown in FIG. 2, the universal linear optical network includes the initial state preparation linear optical network, the unitary operator configuration linear optical network, and the projective measurement linear optical network.

The initial state preparation linear optical network 201 is connected to the configurable entangled multi-photon source, formed into corresponding O₁, O₂, . . . , O_{P} according to the wavelengths of the photons outputted by the wavelength division multiplexer, and configured to prepare an initial state for the photons outputted by the configurable entangled multi-photon source.

The unitary operator configuration linear optical network 202 (including a beam combiner 231) is correspondingly connected to the initial state preparation linear optical network O, so as to form corresponding U₁⁽ⁱ⁾, U₂⁽ⁱ⁾ . . . U_{P}⁽ⁱ⁾ (i=1, 2, . . . , N), and configured to perform unitary transformation, and achieve a linear combination of unitary operators after beam combination is performed, so as to obtain a final quantum state result: (Σᵢ₌₁^{N}αᵢU₁⁽ⁱ⁾⊗U₂⁽ⁱ⁾⊗ . . . U_{P}⁽ⁱ⁾)O₁⊗O₂⊗ . . . O_{P}|0 [symbol] .

The projective measurement linear optical network 203 is correspondingly connected to the unitary operator configuration linear optical network U, so as to form corresponding T₁, T₂ . . . T_{P}, and configured to perform projective measurement on a quantum state after beam combination.

As shown in FIG. 2, the integrated photonic-based programmable high-dimensional quantum computation chip structure provided in the embodiments of the present disclosure includes N entangled multi-photon sources and a ┌log₂ N┐-level Mach-Zehnder interferometer. The N entangled multi-photon sources may be marked as S₁, S₂, . . . , S_{N}, where N is a natural number, and N≥2. The Mach-Zehnder interferometers in a ┌log₂ N┐-level Mach-Zehnder interferometer network are arranged in the form of a binary tree, that is, each output port of the previous level Mach-Zehnder interferometer is connected to an input port of the next level Mach-Zehnder interferometer, and a Nth output port of the last level Mach-Zehnder interferometer is connected to the second phase shifter and one entangled multi-photon source.

Different linear term coefficients may be obtained according to needs by configuring the first phase shifter and the second phase shifter in the configurable entangled multi-photon source to perform the corresponding configuration on each path of light outputted by the linear coefficient configuration network. Each entangled multi-photon source generates the photons with P different wavelengths.

After passing through the wavelength division multiplexer, the photons are respectively routed to entrances of P groups of initial state preparation linear optical networks. The initial state preparation linear optical network is configured to prepare an initial state.

Since each multi-photon source generates the photons with P different wavelengths, the photons with the same wavelength are routed to the same group of initial state preparation linear optical networks. Therefore, as shown in FIG. 2, there are P groups of initial state preparation linear optical networks provided in the embodiments of the present disclosure. The P groups of initial state preparation linear optical networks may be marked as O₁, O₂, . . . , O_{P}, where P is a natural number, and P≥2. There are N initial state preparation linear optical networks in each group.

By means of O₁, O₂, . . . , O_{P}, the preparation of t-dimensional quantum states encoded by P paths may be realized, where initial state |Ψ [symbol] ᵢₙᵢ=O₁⊗O₂⊗ . . . ⊗O_{P}(|0 [symbol] ₁⊗|0 [symbol] ₂⊗ . . . ⊗|0 [symbol] _{P}), and O₁, O₂, . . . , O_{P} may be any t-dimensional linear optical operation. For each O_{M} in the chip, the same operation may be executed, where M is a natural number, and 1≤M≤P.

There are P*N unitary operator configuration linear optical networks, which may be divided into P groups, and each group includes N unitary operator configuration linear optical networks. The first group of unitary operator configuration linear optical networks U₁ is correspondingly connected to the first group of initial state preparation linear optical networks O₁; the second group of unitary operator configuration linear optical networks U₂ is correspondingly connected to the second group of initial state preparation linear optical networks O₂; and the Pth group of unitary operator configuration linear optical networks U_{P} is correspondingly connected to the Pth group of initial state preparation linear optical networks O_{P}.

Specifically, the unitary operator configuration linear optical networks may be marked as U₁⁽¹⁾, U₁⁽²⁾ . . . U₁^{(N)}, U₂⁽¹⁾, U₂⁽²⁾ . . . U₂^{(N)}, . . . , U_{P}⁽¹⁾, U_{P}⁽²⁾ . . . U_{P}^{(N)}.

There are P projective measurement linear optical networks, and each projective measurement linear optical network corresponds to one group of O and U. The P projective measurement linear optical networks may be marked as T₁, T₂, . . . T_{M}, . . . T_{P}, and each T_{M} is provided with t ports.

The initial state preparation linear optical networks, the unitary operator configuration linear optical networks, and the projective measurement linear optical networks are all a plurality of universal linear optical networks that may realize t-dimensional unitary transformations.

In the related techniques of mathematics, the unitary transformation is the transformation that retains an inner product, and an inner product of two vectors before the unitary transformation is equal to an inner product after conversion. The unitary transformation is the transformation that is done by using unitary operators, including the transformation on a basic vector and the transformation on an operator. It may be considered that the unitary transformation is the isomorphism between two Hilbert spaces.

Specifically, if a certain unitary matrix V_{T} is about to be realized, V_{T} here may be represented as V_{T}=αⱼUⱼ, (j=0, 1, 2 . . . n−1), where Uⱼ is a gate acting on a d-dimensional target (T) subspace, and αⱼ is a complex coefficient, meeting Σⱼ₌₀ⁿ⁻¹|αⱼ|²=1. When a controlled Uⱼ gate is available, the V_{T} may be achieved in a probabilistic manner. The αⱼ is encoded as an initial state |ϕ [symbol] _{C}=Σⱼ₌₀ⁿ⁻¹αⱼ|j [symbol] _{C} controlled by k qubits, where n=2^{k}, and j marks a computational basis; and a quantum circuit succeeds when the final measurement of all controlled qubits in the computational basis is 0. The controlled qubits may be acted on unitary qubits more simply by transferring the partial state of a target qubit to an extended Hilbert space. In the embodiments of the present disclosure, a linear combination quantum circuit may be achieved by using a technology based on an extended computational Hilbert space.

Any quantum unitary operation may be decomposed in principle as a linear sum of basic operations. For example, any two qubits unitary operations may be rewritten by using the KAK decomposition of Cartan, and then are converted into a linear combination of four linear terms; and each linear term is a tensor product of two single qubit gates. In addition, a Cartan decomposition method allows n quantum unitary operations to be reconstructed as the linear combination of the tensor products of n single qubit gates. In order to realize the linear combination of quantum operations, coherent control needs to be added for any unknown quantum operation. The technology is based on a gate extended by a logical Hilbert space for computation.

Each entangled multi-photon source generates the photons with P different wavelengths. According to needs, the paths of N entangled multi-photon sources are encoded by first adjusting the phase shifter in the configurable entangled multi-photon source, so as to obtain the linear term coefficient α₁, α₂, . . . α_{N}, thereby obtaining Σᵢ₌₁^{N}αᵢ|i [symbol] ₁|i [symbol] ₂ . . . |i [symbol] _{P}. After passing through the wavelength division multiplexer, the photons enter different initial state preparation linear optical networks according to different wavelengths, and are finally outputted from different projective measurement linear optical networks. In combination with a postselection technology, coincidence measurement |T₁ [symbol] T₁|⊗|T₂ [symbol] T₂|⊗ . . . |T_{P} [symbol] T_{P}|, is performed on the photons with P different wavelengths at the projective measurement linear optical networks, and corresponding multi-photon multipath entangled states are correspondingly generated at the entrance of each optical network of the initial state preparation linear optical network. In the initial state preparation linear optical network, each photon in the Mth group of photons |M [symbol] ₁|M [symbol] ₂ . . . |M [symbol] _{N} with the same wavelength is routed to the initial state preparation linear optical network O_{M}, so as to generate the initial state, and then routed to the unitary operator configuration linear optical networks U_{M}⁽¹⁾, U_{M}⁽²⁾, . . . , U_{M}^{(N)} for unitary transformation and linear combination; beam combination is performed on light paths, and after beam combination, the linear combination of the unitary operators is realized, so as to obtain a final quantum state result: (Σᵢ₌₁^{N}αᵢU₁⁽ⁱ⁾⊗U₂⁽ⁱ⁾⊗ . . . U_{P}⁽ⁱ⁾)O₁⊗O₂⊗ . . . O_{P}|0 [symbol] ; and finally the light paths enter the projective measurement linear optical network T_{M}, so as to perform projective measurement on the quantum state. The initial state preparation linear optical networks, the unitary operator configuration linear optical networks, and the projective measurement linear optical networks are all a plurality of t-dimensional configurable linear optical networks. According to different multi-dimensional entangled photon entangled states, the initial state preparation linear optical networks are recorded as O₁, O₂, . . . O_{M}, . . . O_{P}, where M is a natural number, and 1≤M≤P; and there are N initial state preparation linear optical networks for in each group O_{M}.

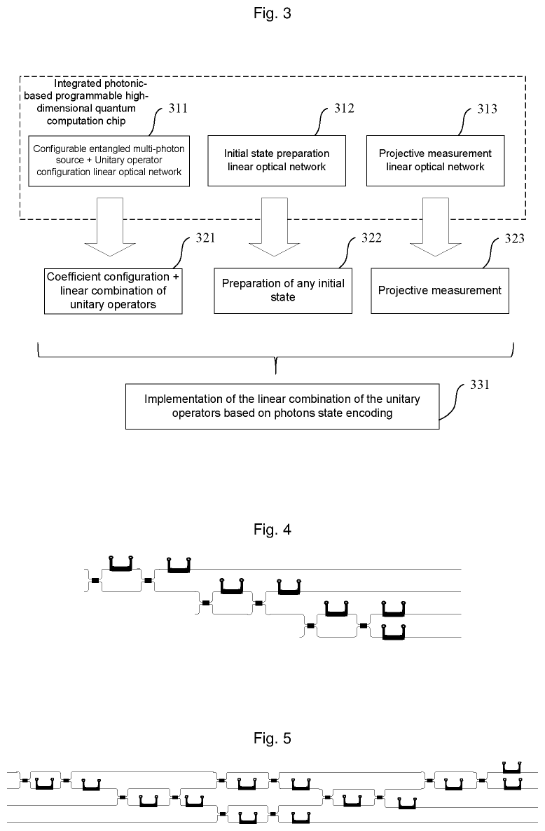

As shown in FIG. 3, in the embodiments of the present disclosure, a module 311 formed by the configurable entangled multi-photon source and the unitary operator configuration linear optical network is configured to execute 321 of performing coefficient configuration and a linear combination of unitary operators. The initial state preparation linear optical network 312 is configured to execute 322 of prepare any initial state. The projective measurement linear optical network 313 is configured to execute 323 of performing projective measurement. Herein, 321, 322 and 323 may be referred collectively as 331 for achieving the linear combination of the unitary operators based on photon path state encoding.

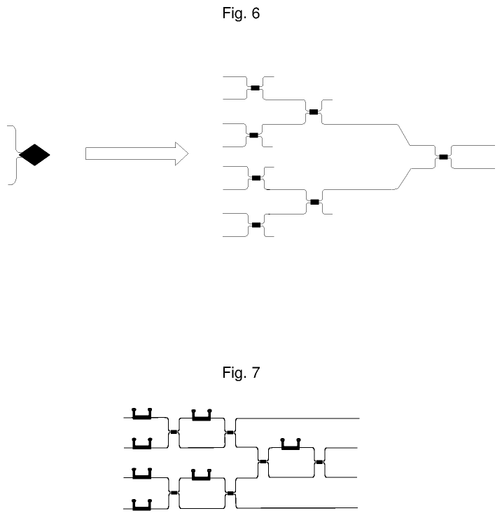

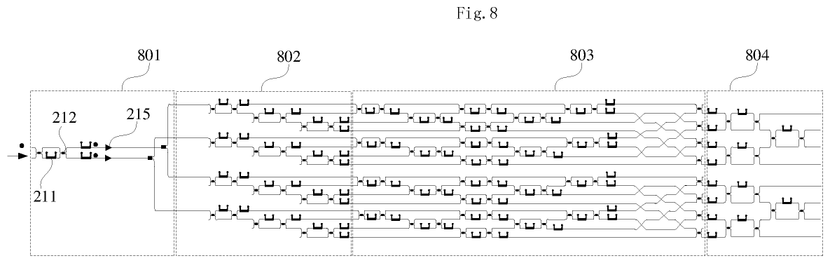

In the embodiments of the present disclosure, the initial state preparation linear optical network may be a multi-level chain structure shown in FIG. 4. The unitary operator configuration linear optical network may include a t-dimensional simplified triangularly-distributed optical network structure shown in FIG. 5. FIG. 6 is a schematic diagram of an optical network structure for photon beam combination. The projective measurement linear optical network may be an inverted tree structure shown in FIG. 7.

For the initial state preparation linear optical network, an initial quantum state may generally be set to |0 [symbol] , which is inputted from a first path module.

The quantum computation operation executed on the integrated photonic-based programmable high-dimensional quantum computation chip is implemented employing the linear combination of unitary operators based on path encoding. Linear coefficients are provided by the configurable entangled multi-photon source. The linear combination of unitary operators is provided by the unitary operator configuration linear optical network. The unitary operator configuration linear optical network includes N*P linear optical networks that may realize the required t-dimensional unitary transformation. Each photon in the Mth group of photons |M [symbol] ₁|M [symbol] ₂ . . . |M [symbol] _{N} with the same wavelength is routed to the initial state preparation linear optical network O_{M}, so as to generate the initial state, then routed to the unitary operator configuration linear optical networks U_{M}⁽¹⁾, U_{M}⁽²⁾, . . . , U_{M}^{(N)}, so as to complete unitary transformation and linear combination, and finally routed to the projective measurement linear optical network, so as to complete projective measurement.

The integrated photonic-based programmable high-dimensional quantum computation chip in the embodiments of the present disclosure is to integrate discrete linear optical elements, in a thin film form, onto a single semiconductor integrated chip by using an integrated photonic technology. Compared with the discrete element optical system, the volume is significantly decreased, and the entire system has better stability and better extendibility because of high integration.

Important components required by the integrated photonic-based programmable high-dimensional quantum computation chip all have been experimentally implemented, respectively, such as on-chip single-photon source and entangled photon source, on-chip wavelength division multiplexer, and on-chip universal linear optical network implementation. On the basis of these integrated chip components, the entangled photons are generated by using an on-chip integrated photon source; the behaviors of the photons are controlled by using the linear optical network formed by an on-chip integrated Mach-Zehnder interferometer and a phase controller; and then the photons are detected by means of an on-chip integrated single photon detector. Therefore, the large-scale integrated photonic-based programmable high-dimensional quantum computation chip may be designed and used for implementing complex quantum information processing applications.

In the embodiments of the present disclosure, by means of an integrated photonic-based programmable high-dimensional quantum computation chip approach, an on-chip path entangled multi-photon source and the universal linear optical network are used cooperatively, so as to build an integrated photonic chip structure. Specifically, in the embodiments of the present disclosure, different multi-photon multipath entangled states are generated by means of the on-chip path entangled multi-photon source; different optical unitary transformations are configured by means of the on-chip universal linear optical network, so as to achieve different computation tasks according to needs; and a quantum information processing result may be obtained by performing output measurement, so as to achieve universal quantum information computation.

In the embodiments of the present disclosure, the first phase shifter and the second phase shifter in the entangled multi-photon source module adjust each path of light by means of external classical control signals, to encode the paths of the N entangled multi-photon sources, so as to obtain the linear term coefficients.

In the embodiments of the present disclosure, there are N initial state preparation linear optical networks in each of the P groups of initial state preparation linear optical networks; correspondingly, the unitary operator configuration linear optical networks are divided into P groups, and each group has N unitary operator configuration linear optical networks; and each group of unitary operator configuration linear optical networks is correspondingly connected to one group of initial state preparation linear optical networks and one projective measurement linear optical network.

The initial state preparation linear optical networks, the unitary operator configuration linear optical networks, and the projective measurement linear optical networks are all a plurality of t-dimensional configurable universal linear optical networks.

By means of the integrated photonic-based programmable high-dimensional quantum computation chip approach, an organic combination between the multi-photon source that may prepare the multi-photon path entangled state and the linear optical network that may realize unitary transformation is realized. By regulating the multi-photon path entangled state prepared by the multi-photon source, and configuring different optical unitary transformations through the on-chip universal linear optical network, the integrated photonic-based programmable high-dimensional quantum computation chip may realize programmable high-dimensional qubits computation by preparing a multi-photon high-dimensional entangled quantum state and using the linear combination of unitary operators.

Described above is the technical solution for achieving t-dimensional qubits computation by using the N-dimensional entangled quantum state of P particles.

FIG. 8 is a schematic structural diagram of an integrated photonic-based programmable high-dimensional quantum computation chip for realizing four-dimensional qubits computation.

In the configurable entangled multi-photon source 801, an initial state of a two-photon source is configured by adjusting the phase shifter in the configurable entangled multi-photon source 801, so as to obtain the linear term coefficient α₁ and α₂. Each entangled multi-photon source generates frequency-entangled photon pairs; and the wavelength division multiplexer is used to separate a signal photon and an idler photon of the entangled photon source that is generated through four-wave mixing. The configurable entangled multi-photon source 801 generates the photons with 2 wavelengths, and routes the photons to different networks of the initial state preparation linear optical network 802 according to the wavelengths.

The initial state preparation linear optical network 802 prepares entangled photons obtained by the entangled multi-photon source into any initial state, and then routes the photons to the unitary operator configuration linear optical network 803. The unitary operator configuration linear optical network 803 includes 4 linear optical networks, which are U₁⁽¹⁾, U₁⁽²⁾, U₂⁽¹⁾ and U₂⁽²⁾, and the linear optical networks are all four-dimensional linear optical network structures, such that the linear combination of unitary operator scheme based on path encoding may be realized.

The unitary operator configuration linear optical network 803 routes the photons after linear combination to the projective measurement linear optical network 804 for projective measurement.

In the embodiments of the present disclosure, the paths of 2 entangled multi-photon sources are encoded by first adjusting the phase shifter in the configurable entangled multi-photon source 801, so as to obtain the linear term coefficient α₁, α₂, thereby obtaining Σᵢ₌₁²αᵢ|i [symbol] ₁|i [symbol] ₂. After passing through the wavelength division multiplexer, the photons enter different linear optical networks according to different wavelengths, and are finally outputted from different projective measurement optical networks. In combination with a postselection technology, coincidence measurement |T₁ [symbol] T₁|⊗|T₂ [symbol] T₂| is performed on the photons with 2 different wavelengths at the projective measurement linear optical networks, and corresponding multi-photon multipath entangled states are correspondingly generated at the entrance of each optical network of the initial state preparation linear optical network. In the initial state preparation linear optical network, each photon in the Mth group of photons |M [symbol] ₁|M [symbol] ₂ with the same wavelength is routed to the initial state preparation linear optical network O_{M}, so as to generate the initial state, and then routed to the unitary operator configuration linear optical networks U_{M}⁽¹⁾ and U_{M}⁽²⁾, so as to form the linear combination; and finally, beam combination is performed on the light path to enter the projective measurement linear optical network T_{M} for analysis measurement. Herein, M=1 or 2. The initial state preparation linear optical networks, the unitary operator configuration linear optical networks, and the projective measurement linear optical networks are all four-dimensional configurable linear optical networks.

In the present disclosure, the integrated photonic-based programmable high-dimensional quantum computation chip may be implemented in the form of quantum computation of (Σᵢ₌₁^{N}αᵢU₁⁽ⁱ⁾⊗U₂⁽ⁱ⁾⊗ . . . U_{P}⁽ⁱ⁾)O₁⊗O₂⊗ . . . O_{P}|0 [symbol] , where U_target=Σᵢ₌₁^{N}αᵢU₁⁽ⁱ⁾⊗U₂⁽ⁱ⁾⊗ . . . U_{P}⁽ⁱ⁾ is a quantum operation to be implemented, and represents a linear combination of a plurality of linear optical unitary transformations U; αᵢ is a linear term coefficient; and a computation initial state is O₁⊗O₂⊗ . . . O_{P}|0 [symbol] , and the quantum computation result is a multi-photon high-dimensional quantum state.

The entire integrated photonic-based programmable high-dimensional quantum computation chip structure shown in FIG. 8 may be controlled by 97 phase shifters. These phase shifters adjust each path of light by means of the external classical control signals; and the programmable photonic quantum computation chip is realized by applying different external classical control signals on each phase shifter. The finally obtained result=(Σᵢ₌₁^{N}αᵢU₁⁽ⁱ⁾⊗U₂⁽ⁱ⁾⊗ . . . U_{P}⁽ⁱ⁾)O₁⊗O₂⊗ . . . O_{P}|0 [symbol] =(α₁U₁⁽¹⁾⊗U₂⁽¹⁾+α₂U₁⁽²⁾⊗U₂⁽²⁾)O₁⊗O₂|0 [symbol] |0 [symbol] .

In another embodiment of the present disclosure, the configurable entangled multi-photon source includes 3 entangled multi-photon sources, and each entangled multi-photon source generates photons with 3 different wavelengths. According to needs, the paths of 3 entangled multi-photon sources are encoded by first adjusting the phase shifter in the configurable entangled multi-photon source, so as to obtain the linear term coefficient α₁, α₂, α₃, thereby obtaining Σᵢ₌₁³αᵢ| [symbol] ₁|i [symbol] ₂|i [symbol] ₃. After passing through the wavelength division multiplexer, the photons enter different initial state preparation linear optical networks according to different wavelengths, and are finally outputted from different projective measurement linear optical networks. In combination with a postselection technology, coincidence measurement |T₁ [symbol] T₁|⊗|T₂ [symbol] T₂|⊗|T₃ [symbol] T₃| is performed on the photons with 3 different wavelengths at the projective measurement linear optical networks, and corresponding multi-photon multipath entangled states are correspondingly generated at the entrance of each optical network of the initial state preparation linear optical network. In the initial state preparation linear optical network, each photon in the Mth group of photons |M [symbol] ₁|M [symbol] ₂|M [symbol] ₃ with the same wavelength is routed to the initial state preparation linear optical network O_{M}, so as to generate the initial state, and then routed to the unitary operator configuration linear optical networks U_{M}⁽¹⁾, U_{M}⁽²⁾ and U_{M}⁽³⁾, so as to form the linear combination; and finally, beam combination is performed on the light path to enter the projective measurement linear optical network T_{M} for analysis measurement. Herein, M is 1, 2 or 3. The finally obtained result=(Σᵢ₌₁³αᵢU₁⁽ⁱ⁾⊗U₂⁽ⁱ⁾⊗U₃⁽ⁱ⁾)O₁⊗O₂⊗O₃|0 [symbol] .

In still another embodiment of the present disclosure, the configurable entangled multi-photon source includes 2 entangled multi-photon sources, and each entangled multi-photon source generates photons with 3 different wavelengths. According to needs, the paths of 2 entangled multi-photon sources are encoded by first adjusting the phase shifter in the configurable entangled multi-photon source, so as to obtain the linear term coefficient α₁, α₂, thereby obtaining Σᵢ₌₁²αᵢ|i [symbol] ₁|i [symbol] ₂|i [symbol] ₃. After passing through the wavelength division multiplexer, the photons enter different initial state preparation linear optical networks according to different wavelengths, and are finally outputted from different projective measurement linear optical networks. In combination with a postselection technology, coincidence measurement |T₁ [symbol] T₁|⊗|T₂ [symbol] T₂|⊗|T₃ [symbol] T₃| is performed on the photons with 3 different wavelengths at the projective measurement linear optical networks, and corresponding multi-photon multipath entangled states are correspondingly generated at the entrance of each optical network of the initial state preparation linear optical network. In the initial state preparation linear optical network, each photon in the Mth group of photons |M [symbol] ₁|M [symbol] ₂ with the same wavelength is routed to the initial state preparation linear optical network O_{M}, so as to generate the initial state, and then routed to the unitary operator configuration linear optical networks U_{M}⁽¹⁾ and U_{M}⁽²⁾, so as to form the linear combination; and finally, beam combination is performed on the light path to enter the projective measurement linear optical network T_{M} for analysis measurement. Herein, M is 1, 2 or 3. The finally obtained result=(Σᵢ₌₁²αᵢU₁⁽ⁱ⁾⊗U₂⁽ⁱ⁾⊗U₃⁽ⁱ⁾)O₁⊗O₂⊗O₃|0 [symbol] .

In the embodiments of the present disclosure, high-dimensional qubits computation is realized by means of the linear combination of unitary operator based on path encoding; and by means of regulating the multi-photon path entangled state prepared by the entangled multi-photon source and optical unitary transformation realized by the unitary operator configuration linear optical network, high-dimensional multi-bit quantum computation is realized in combination with on-chip high-dimensional multi-photon path entanglement and by means of path encoding-based linear combination.

The coefficients of optical unitary operation terms of the linear combination are configured through the phase shifters in the configurable entangled multi-photon source; each initial state is prepared through the initial state preparation linear optical network; each item of the unitary transformation and the linear combination are realized through the unitary operator configuration linear optical network; and finally, projective measurement is performed by using the projective measurement linear optical network, so as to obtain the computation result. Based on this, the integrated photonic-based programmable high-dimensional quantum computation chip may complete a multi-particle high-dimensional entangled quantum state, so as to realize high-dimensional qubits computation.

According to the integrated photonic-based programmable high-dimensional quantum computation chip provided in the embodiments of the present disclosure, by generating the plurality of photons, encoding the path of the entangled multi-photon source, and performing, by the linear optical network, initial state preparation, unitary transformation, linear combination, and projective measurement on the photons respectively routed according to the wavelengths, functions, such as generation, control and measurement, of quantum information carriers are realized on a single integrated photonic chip, so as to make it possible to realize an integrated, miniaturized, extensible, and programmable quantum computation apparatus.

Finally, it should be noted that the above embodiments are merely for describing and not intended to limit the technical solutions of the present disclosure. Although the disclosure has been described in detail with reference to the above embodiments, those of ordinary skill in the art should understand that, they can still make modifications to the technical solutions recited in the above embodiments or make equivalent replacements to a part of the technical features thereof; and the modifications or replacements do not cause essence of the corresponding technical solutions to depart from the spirit and scope of the technical solutions of the embodiments of the present disclosure.

What is claimed is:

1. An integrated photonic-based programmable high-dimensional quantum computation chip, comprising:
a configurable entangled multi-photon source, comprising a linear coefficient configuration network, N entangled multi-photon sources and a wavelength division multiplexer, and configured to generate multiple photons, the number of entangled photons generated by each entangled multi-photon source being recorded as P, respectively output the photons with different wavelengths by means of the wavelength division multiplexer, and configure, according to an output path, pump light entering an interference configuration network by adjusting a first phase shifter and a second phase shifter in the linear coefficient configuration network, so as to obtain a group of linear configuration coefficients, which are recorded as α₁, α₂, . . . , and α_{N};
an initial state preparation linear optical network O, connected to the configurable entangled multi-photon source, formed into corresponding O₁, O₂, . . . , O_{P} according to the wavelengths of the photons outputted by the wavelength division multiplexer, and configured to prepare an initial state for the photons outputted by the configurable entangled multi-photon source;
a unitary operator configuration linear optical network U, correspondingly connected to the initial state preparation linear optical network O, so as to form corresponding U₁⁽ⁱ⁾, U₂⁽ⁱ⁾ . . . U_{P}⁽ⁱ⁾ (i=1, 2, . . . , N), and configured to perform unitary transformation, and achieve a linear combination of unitary operators after beam combination is performed, so as to obtain a final quantum state result: (Σᵢ₌₁^{N}αᵢU₁⁽ⁱ⁾⊗U₂⁽ⁱ⁾⊗ . . . U_{P}⁽ⁱ⁾)O₁⊗O₂⊗ . . . O_{P}|0 [symbol] ; and
a projective measurement linear optical network T, correspondingly connected to the unitary operator configuration linear optical network U, so as to form corresponding T₁, T₂, . . . , T_{P}, and configured to perform projective measurement on a quantum state after beam combination.

2. The integrated photonic-based programmable high-dimensional quantum computation chip according to claim 1, wherein the initial state preparation linear optical network, the unitary operator configuration linear optical network, and the projective measurement linear optical network all belong to universal linear optical networks.

3. The integrated photonic-based programmable high-dimensional quantum computation chip according to claim 1, wherein the configurable entangled multi-photon source, the initial state preparation linear optical network, the unitary operator configuration linear optical network, and the projective measurement linear optical network all achieve path encoding using the first phase shifter and the second phase shifter.

4. The integrated photonic-based programmable high-dimensional quantum computation chip according to claim 1, wherein the linear coefficient configuration network comprises a log₂ N level Mach-Zehnder interferometer, which is arranged in the form of a binary tree, that is, each output port of the previous level Mach-Zehnder interferometer is connected to an input port of the next level Mach-Zehnder interferometer, and a 2^{┌log}^{₂} ^{N┐}th output port of the last level Mach-Zehnder interferometer is connected to a second phase shifter and a entangled multi-photon source; and the Mach-Zehnder interferometer comprises one first phase shifter and two multimode interferometers connected to the first phase shifter.

5. The integrated photonic-based programmable high-dimensional quantum computation chip according to claim 1, wherein the configurable entangled multi-photon source generates the photons with P wavelengths; and the photons of the P wavelengths are respectively correspondingly routed to P groups of initial state preparation linear optical networks, wherein P is a natural number, and P≥2.

6. The integrated photonic-based programmable high-dimensional quantum computation chip according to claim 1, wherein the initial state preparation linear optical network comprises a multi-level chain structure.

7. The integrated photonic-based programmable high-dimensional quantum computation chip according to claim 1, wherein the unitary operator configuration linear optical network is a triangularly-distributed optical network structure.

8. The integrated photonic-based programmable high-dimensional quantum computation chip according to claim 1, wherein the projective measurement linear optical network comprises an inverted tree structure.

9. The integrated photonic-based programmable high-dimensional quantum computation chip according to claim 3, wherein the first phase shifter and the second phase shifter adjust each path of light by means of external classical control signals, so as to achieve path encoding.

10. The integrated photonic-based programmable high-dimensional quantum computation chip according to claim 5, wherein there are N initial state preparation linear optical networks in each of the P groups of initial state preparation linear optical networks; correspondingly, the unitary operator configuration linear optical networks are divided into P groups, and each group has N unitary operator configuration linear optical networks; there are P projective measurement linear optical networks; and each group of unitary operator configuration linear optical networks is correspondingly connected to one group of initial state preparation linear optical networks and one projective measurement linear optical network.
